(19) United States
(12) Patent Application Publication
(10) Pub. No.: US 2013/0232187 A1
(43) Pub. Date: Sep. 5, 2013

(54) SYSTEMS AND METHODS FOR MANAGING DATA IN A NETWORKED COMMUNICATION SYSTEM

(71) Applicants: Antony Workman, Bolton (GB); Joseph Saib, Santa Clara, CA (US); Jonathan Wallace, Coral Springs, FL (US)

(72) Inventors: Antony Workman, Bolton (GB); Joseph Saib, Santa Clara, CA (US); Jonathan Wallace, Coral Springs, FL (US)

(73) Assignee: AppSense, Inc., New York, NY (US)

(21) Appl. No.: 13/412,505

(22) Filed: Mar. 5, 2012

(51) Int. Cl. G06F 15/16

(52) U.S. Cl. 709/203

(57) ABSTRACT

Systems and methods are provided for managing data in a networked communication system. In particular, certain embodiments of the disclosed subject matter include an apparatus having a processor configured to run a module stored in memory that is configured to receive a first data request requesting the apparatus to provide contents of a data file, to determine that the data file is associated with a remote data file at the server, and based on the determination, to send a second data request to the server to provide the data file to the apparatus, and to receive a response to the second data request from the server, the response including the contents of the data file.

### BACKGROUND

1. Technical Field

Disclosed systems and methods relate to managing data in a networked communication system.

2. Description of the Related Art

Traditionally, computing devices managed data files locally. For example, a computer stored data files on a local storage medium and accessed the contents of the data files by retrieving them from the local storage medium. Oftentimes, the local storage medium could only be accessed by the computing device being physically coupled to the storage medium. Therefore, the management of data files on a local storage medium was largely independent of other computing devices. Such a local data file management had some benefits, one of which includes the speed at which data files could be stored and accessed.

However, the local management of data files rendered certain data management tasks cumbersome, especially the sharing of data files amongst multiple computing devices. For example, every time a user wanted to provide a data file to another computer, the user had to copy the data file into a portable storage medium, such as a portable hard disk or a Universal Serial Bus (USB) drive, and copy the data file in the portable storage medium to the destination computing device. Because this mechanism involves a physical coupling of the portable storage medium to the destination computing device, sharing of data files was slow, involved too much user interaction, and at best cumbersome.

Some of these issues have been addressed with communication networks. Communication networks enable server/client systems to share data files amongst multiple computing devices. A server/client data sharing system allows clients, such as computers, to locally access data files, just as in traditional computing devices. However, a server/client data sharing system also allows clients to access data files at a remote server via communication networks. Such a remote data access allows users to store data files at a remote server and access those files from any clients that are coupled to the remote server. Existing implementations of server/client data sharing systems include web-folder services, such as DROPBOX, INC., a Network File System (NFS,) or an Andrew File System (AFS.)

Existing server/client systems clearly distinguish remote data files (e.g., data files at a remote server) from local data files (e.g., data files stored at a local storage medium coupled to a client), and such a clear distinction is integrated into the design and operation of the server/client data sharing systems. For example, certain server/client systems maintain two types of folders: a remote folder dedicated entirely to remote data files and a local folder dedicated entirely to local data files. In some instances, server/client systems even require users to use different techniques and/or interfaces to access remote data files. For example, users need to access remote data files via a predefined interface, such as a web interface.

Because server/client systems distinguish remote data files from local data files, the interaction with remote data files is not as seamless as the interaction with local data files. While some techniques, such as an automatic synchronization of data files, have been developed to improve the user interaction with remote data files, such techniques come at the cost of increased data traffic and computing power. Additionally, existing server/client systems require downloading remote data files every time the user wants to access the same remote data file over time, which can unnecessarily consume communication bandwidths.

Therefore, there is a need in the art to provide systems and methods for improving interactions with remote data files. Accordingly, it is desirable to provide methods and systems that overcome these and other deficiencies of the related art.

### SUMMARY

In accordance with the disclosed subject matter, systems and methods are provided for managing data in a networked computer system.

Disclosed subject matter includes a non-transitory computer readable medium having executable instructions. The executable instructions are operable to cause a data processing apparatus to provide, to a user interface coupled to the data processing apparatus, a list of data files, the data files including at least one remote data file and at least one local data file, where the at least one remote data file is provided to the user interface as a local data file. The executable instructions are further operable to receive, from the user interface, a first data request requesting the data processing apparatus to provide contents of a data file, to determine that the requested data file is a remote data file that is maintained at a server, and based on the determination, send a second data request via a computer network to the server, requesting the server to provide the data file to the data processing apparatus. The executable instructions are operable to receive a response to the second data request from the server, the response including the contents of the data file.

Disclosed subject matter includes an apparatus including a user interface configured to provide and receive data, one or more interfaces configured to provide communication with a server via a communication network, and a processor, in communication with the one or more interfaces. The processor is configured to run a module stored in memory that is configured to provide, to the user interface, a list of data files including at least one remote data file and at least one local data file, where the at least one remote data file is provided to the user interface as a local data file. The module is further configured to receive, from the user interface, a first data request requesting the apparatus to provide a contents of a data file, to determine that the data file is associated with a remote data file at the server, and based on the determination, to send a second data request to the server to provide the remote data file to the apparatus. The module is further configured to receive a response to the second data request from the server, the response including the contents of the data file.

Disclosed subject matter includes a method including providing, to a user interface coupled to an apparatus, a list of data files, the data files including at least one remote data file and at least one local data file, wherein the at least one remote data file is provided to the user interface as a local data file. The method further includes receiving, at the apparatus from the user interface, a first data request requesting to provide contents of a data file, determining that the requested data file is a remote data file that is stored at a server, and based on the determination, sending a second data request via a computer network to the server, requesting the server to provide the data file to the apparatus. The method also includes receiving a response to the second data request from the server, the response including the contents of the data file.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system in accordance with an embodiment of the disclosed subject matter.

FIG. 2 illustrates a flow diagram illustrating an operation of a client when a user requests the client to identify data files in a folder, in accordance with certain embodiments of the disclosed subject matter.

FIG. 3 illustrates a flow diagram illustrating how the client interacts with the server to receive information about a remote data file in accordance with certain embodiments of the disclosed subject matter.

FIG. 4 illustrates a flow diagram illustrating an operation of a client when a user requests the contents of a data file for the first time in accordance with certain embodiments of the disclosed subject matter.

FIG. 5 illustrates a flow diagram illustrating how the client interacts with the server to receive the contents of a remote data file in accordance with certain embodiments of the disclosed subject matter.

FIG. 6 illustrates a flow diagram illustrating an operation of a client when a user requests the client to provide a remote data file that has previously been downloaded by the client, in accordance with certain embodiments of the disclosed subject matter.

FIG. 7 illustrates a block diagram of a client in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

At a high level, the disclosed subject matter relates to systems and methods for providing a seamless interaction with remote data files in a server/client data sharing system. There are at least two components to the disclosed subject matter: (1) a user interface at the client and (2) an automatic communication between the client and the server to communicate information about remote data files. The disclosed server/client data sharing system includes a client having a user interface. This user interface provides users with a mechanism to browse through the folders and data files in a file system. Unlike existing user interfaces, this user interface is designed not to distinguish remote data files from local data files. For example, when the user interface lists data files associated with a folder, the user interface does not indicate whether a data file is a remote data file residing at the server or a local data file that resides at a local storage medium. Instead, the user interface presents the remote data files in the same format as the local data files, as to disguise the fact that the data file is a remote data file. Therefore, just by viewing the files via this user interface, the user would not be able to determine whether a data file is a remote data file or a local data file. Therefore, the user would believe that the data files are all stored locally at a local storage medium. This can improve the user experience with remote data files because the user does not have to worry about whether a data file is at a remote server or stored locally.

In the disclosed server/client system, the client is also configured to automatically communicate with servers to send and/or receive information about remote data files. In other words, the client is configured to send and/or receive information about remote data files even if the user is oblivious of the remote data files and does not specifically request the client and/or server to receive such information from the server. The user is shielded from the burden of saving and/or requesting remote data files at the server; the client handles that automatically. For example, when a user requests the client to provide a list of files in a folder, the client can determine if the folder includes any remote data files. If one of the data files in the folder is a remote data file, the client can automatically request the remote server to provide information about the identified remote data file. When the client receives the requested information from the server, the client can present the received information as if the associated data file is a local data file. Also, when a user requests to retrieve the contents of a remote data file, the client can automatically request and receive it from the remote server. The client would then store the received data file at a local storage medium and present the received data file to the user. To a user, because the client automatically manages the remote data files, the interaction with remote data files is indistinguishable from the interaction with local data files. Therefore, the user would actually believe that the data files are all stored locally at a local storage medium.

Because the client still needs to communicate over communication networks to send and/or receive remote data files, a slight delay can exist between the time at which the user issues a request for a remote data file and the time at which the user receives the requested remote data file. Certain embodiments of the disclosed subject matter illustrate techniques that can reduce the delay in accessing remote data files. For example, a client can maintain a running list of remote data files that have already been downloaded previously and stored at a local storage medium. If a user is requesting a data file that has already been downloaded, and if the previously downloaded version is identical to the latest version of the requested data file at the remote server, the client can provide the local version without downloading the data file from the server. Also, if a user is requesting a data file that has already been downloaded, but if the previously downloaded version is not identical to the actual data file at the remote server, the client can request the server to provide a portion of the remote data file. In some cases, the requested portion can include only the difference between the previously downloaded version and the current version at the server. In other cases, the requested portion can include the difference as well as some of the portions already downloaded. Yet in other cases, the requested portion can include the actual data file at the remote server in its entirety.

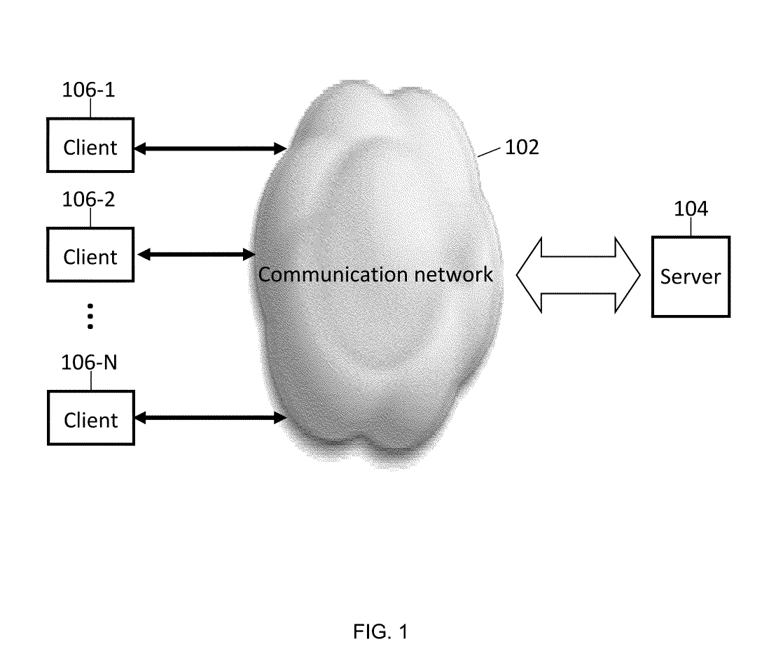

FIG. 1 illustrates a diagram of a networked communication system in accordance with an embodiment of the disclosed subject matter. FIG. 1 includes a communication network 102, a server 104, and at least one client 106 (e.g., client 106-1, 106-2, . . . 106-N). The communication network 102 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. Although FIG. 1 represents the network 102 as a single network, the network 102 can include multiple interconnected networks listed above. Each client 106 can include a desktop computer, a mobile computer, a tablet computer, a cellular device, or any other computing devices having a processor and memory. Each client 106 can communicate with the server 104 via the communication network 102 to access remote data files. Although FIG. 1 represents the server 104 as a single server, the server 104 can include more than one server and can be part of a cloud-computing platform.

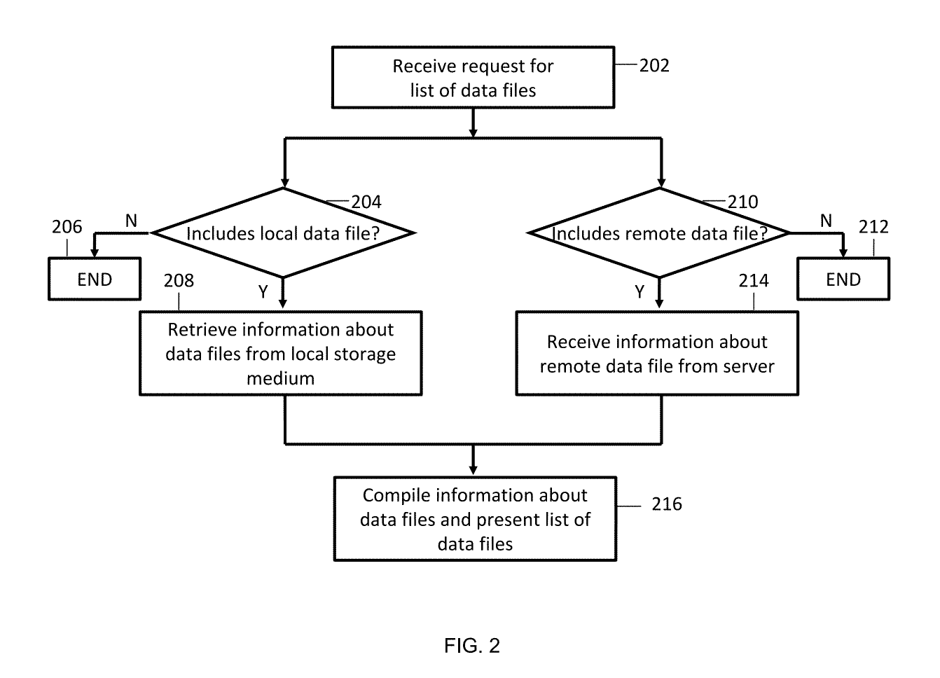

FIG. 2 illustrates a flow diagram illustrating an operation of a client when a user requests the client to list data files in a folder, in accordance with certain embodiments of the disclosed subject matter. When a user requests the client to list data files in a folder, the client can present the list of data files and information related to the data files, for example, metadata. The metadata can include one or more of a name of the data file, the file extension of the data file, a file size indicator indicating a size of the data file, a created time identifier indicating a time at which the data file was created, a time stamp indicating a time at which the data file was last modified, the directory of the data file at a file system, and any other relevant information or combination of information.

In some embodiments, a client 106 can maintain information about the data files in a local storage medium, regardless of whether the associated data files are locally stored or remotely maintained. In this case, the client 106 can retrieve the information from the local storage medium and present the retrieved information to the user. In other embodiments, the client 106 can maintain only the information about local data files and not that of remote data files. In this case, the client 106 can receive the information about remote data files from the server so that the client 106 can present a list of data files including both the local data files and the remote data files, displaying the same type of information for both the local data files and the remote data files. The flow diagram of FIG. 2 illustrates a mechanism via which the client 106 can receive the information about remote data files and present remote data files indistinguishably from local data files.

In step 202, a client 106 can receive a request from a user, requesting the client 106 to provide a list of data files in a folder. For example, the client 106 can detect an event in which the user opens a file manager and double-clicks the folder. In step 204, upon receiving the request from the user, the client 106 can determine if the folder includes any local data files. In some embodiments, the client 106 can analyze a “scope” field associated with a data file to determine if the data file is a local data file. For example, if the scope field indicates “local,” then the data file is maintained at a local storage medium. If the folder does not include any local data files, then the client 106 can proceed to step 206 and terminate this branch of the flow diagram. If the folder includes at least one local data file, the client 106 can proceed to step 208. In step 208, the client can retrieve information about the local data files in the folder and prepare the information for presentation to the user.

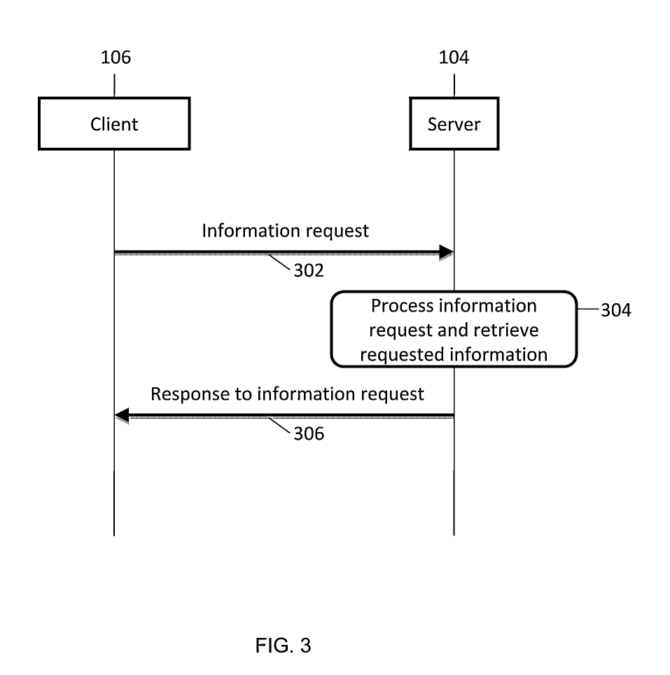

In step 210, upon receiving the request from the user, the client 106 can also determine if the folder includes any remote data files. In some embodiments, the client 106 can analyze a “scope” field associated with a data file to determine if the data file is a remote data file. For example, if the scope field indicates “remote,” then the data file is maintained at the server 104. If the folder does not include any remote data files, then the client 106 can proceed to step 212 and terminate this branch of the flow diagram. If the folder includes at least one remote data file, the client 106 can proceed to step 214. In step 214, the client 106 can communicate with the server 104 to receive information about the remote data files in the folder and prepare the information for presentation to the user. An embodiment of this process is detailed in FIG. 3.

FIG. 2 shows path 204-206-208 and path 210-212-214 being processed in parallel upon receiving the request from the user in step 202 in certain embodiments of the disclosed subject matter. In other embodiments of the disclosed subject matter, path 204-206-208 and path 210-212-214 can be processed in parallel, serially in any suitable order, or any suitable combination thereof.

In step 216, the client 106 can use the determined information about the data files to provide the requested list of files, including one or more of the local data files and the remote data files. The client can format the list of data files such that the same type of information (e.g., metadata) accompanies the local data files and the remote data files. This way, the user viewing the list of files would not be able to distinguish the local data files and the remote data files and would believe that the data files are all stored locally in a local storage medium.

FIG. 3 illustrates a flow diagram illustrating how the client interacts with the server to receive information about a remote data file in accordance with certain embodiments of the disclosed subject matter. The illustrated process can be used in step 214 of FIG. 2.

In step 302, the client 106 can send an information request to the server 104, requesting the server 104 to provide information about one or more remote data files. The information request can be formatted as an Extensible Markup Language (XML), Google Protobuf, or any other formats suitable for data communication. The information request can include authorization information and a data identifier. The authorization information indicates that the client 106 is authorized to access the files at the server 104. The authorization information can include a cookie or a session token, which is a string of alphanumeric characters associated with the established session. The client 106 can receive the cookie or the session token from the server 104 when the client 106 establishes a session with the server 104.

The data identifier in the information request can include a remote folder identifier and/or a remote file identifier. In some embodiments, if the data identifier includes a remote folder identifier, the information request would indicate to the server 104 that the server 104 should provide information about all the files in the folder associated with the remote folder identifier. In some embodiments, if the data identifier includes a list of remote file identifiers, this would indicate to the server 104 that the server 104 should provide information about remote files associated with the list of remote file identifiers.

In some embodiments, a remote folder identifier can identify two types of information: (1) the server in which the remote folder resides, and (2) the directory (or path) of the folder at the identified server. The server in which the folder resides can be identified by the server's network name. The network name can include a fully qualified domain name (FQDN). Thus, a remote folder identifier can include a concatenation of the server's FQDN and the directory (or path) of the folder at the server. For example, to identify a folder “Joseph” at a server 104 having an FQDN, “localhost.saib.com,” the remote folder identifier can be “localhost.saib.com/Joseph.”

In certain embodiments, the client 106 can prepare the remote folder identifier by translating a local folder identifier (i.e., a folder identifier identifying a folder at the client's file system). This translation can be performed using a directory conversion module. For example, when a user requests the client to provide a list of files at the local folder identifier, “C:\Joseph,” and if the corresponding remote folder resides at a server, “localhost.saib.com”, the directory conversion module can translate “C:\” to “localhost.saib.com” and concatenate “localhost.saib.com” to “Joseph”: “localhost.saib.com/Joseph.”

A remote file identifier can identify two types of information: (1) a remote folder identifier, as described above, and (2) a filename. For example, a file having a name, “AppSense.txt,” at a folder “Joseph” at a server identified as “localhost.saib.com” can be identified using a remote file identifier: “localhost.saib.com/Joseph/AppSense.txt.” As described above, a directory conversion module can prepare remote folder identifiers in the remote file identifiers.

In step 304, the server 104 analyzes the received information request. First, the server 104 analyzes the authorization information in the information request to determine if the client 106 is authorized to access files at the server 104. If the client 106 is authorized, then the server 104 can analyze the data identifier in the information request to determine the information requested by the client 104. If the data identifier includes a remote folder identifier, the server 104 can prepare a list of files in the identified folder and metadata associated with those files. If the data identifier includes a list of remote file identifiers, the server 104 can prepare metadata of files identified by the list of remote file identifiers. In step 306, the server 104 provides the retrieved information about the requested data files to the client 106. The client 106 can use this information in step 216 (FIG. 2) to provide a list of data files including one or more remote data files.

Once the user views the list of data files in a folder, the user can request the client 106 to provide the contents of one of the listed data files. If the requested data file is a local data file, then the client 106 can retrieve the data file from a local storage medium and provide it to the user. If the requested data file is a remote data file, then the client 106 can download the requested file from the server 104 and provide the received data file to the user.

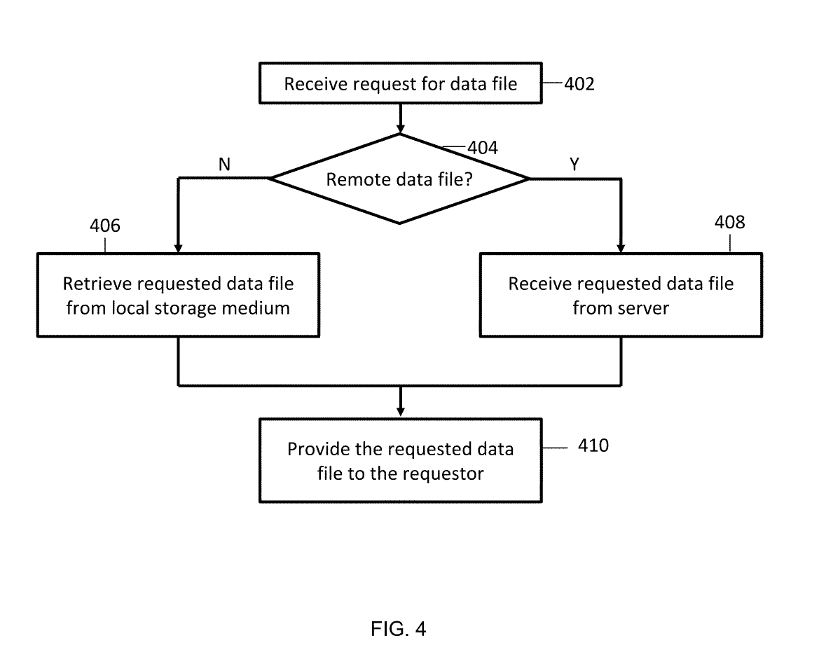

FIG. 4 illustrates a flow diagram illustrating an operation of a client when a user requests the contents of a data file for the first time in accordance with certain embodiments of the disclosed subject matter.

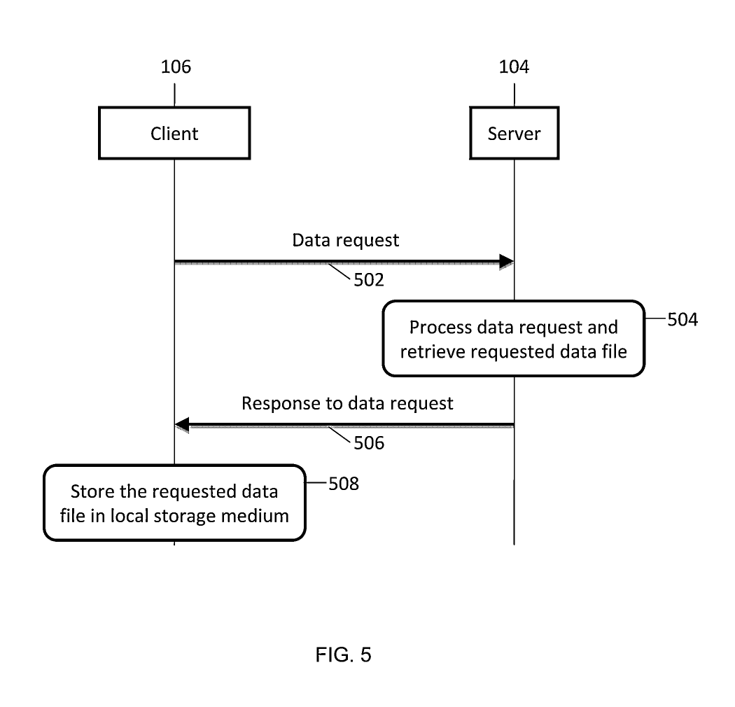

In step 402, a client 106 can receive a request, from a user, to provide the contents of a data file. For example, the client 106 can detect an event in which the user opens a file manager and double-clicks on one of the files listed in the file manager. In step 404, upon receiving the request from the user, the client 106 can determine if the identified file is a local data file or a remote data file. If the identified file is a local data file, then the client 106 can proceed to step 406 to retrieve the data file from a local storage medium and to provide the retrieved file to the user. If the identified file is a remote data file, then the client can proceed to step 408. In step 408, the client 106 can request the server 104 to provide the requested data file. An embodiment of this process is detailed in FIG. 5. Then in step 410, the client 106 can provide the requested data, whether it is the local data file or the remote data file, to the user.

FIG. 5 illustrates a flow diagram illustrating how the client interacts with the server to receive the contents of a remote data file in accordance with certain embodiments of the disclosed subject matter. The illustrated process can be used in step 408 of FIG. 4.

In step 502, the client 106 can send a data request to the server 104, requesting the server 104 to provide the contents of a remote data file to the client 106. The data request can include authorization information and a remote file identifier identifying the user-selected data file. The remote file identifier in the data request can be substantially similar to the remote file identifier of the information request, discussed with respect to FIG. 3. The data request can optionally indicate that the client 106 wants to receive only a portion of the requested data file. In some embodiments, the data request can indicate the desired portion of the requested data file using a range of bits of the requested data file. The data request can be formatted as an Extensible Markup Language (XML), Google Protobuf, or any other formats suitable for data communication.

In step 504, the server 104 analyzes the authorization information in the data request to determine if the client 106 is authorized to access the files in the server 104. If the client 106 is authorized, the server 104 can retrieve the requested data file, and in step 506, provides the requested data file to the client 106. In step 508, the client 106 can store the received data file at a local storage medium. In some embodiments, the client 106 can store the received data file at a location identified by a local file identifier corresponding to the remote file identifier.

In some embodiments, in step 506, instead of providing the requested data file in its entirety, the server 104 can provide only a predetermined portion of the requested data file, even if the client 106 did not specifically ask to provide only a portion of the data file. For example, if the requested data file is a document having 100 pages, the server 104 can determine that the document is too large to send in its entirety. Therefore, the server 106 can initially provide the first ten pages of the document and wait for the client 106 to send another request for additional portions of the data file (e.g., the rest of the document.) When the client 106 receives only a portion of the requested data file, the client 106 can use a tracking module to determine how much of the received data has been consumed by the user and/or how much of the received data is yet to be consumed by the user. If the amount of remaining downloaded data is less than a predetermined threshold, the client 106 can request the server 104 to provide additional portions of the data file.

In certain embodiments, a single request can operate as the information request of step 302 (FIG. 3) and the data request of step 502 (FIG. 5). For example, when a request includes a remote folder identifier, the server 104 can interpret the request as the information request of step 302; when the request includes a remote file identifier, the server 104 can interpret the request as the data request 502.

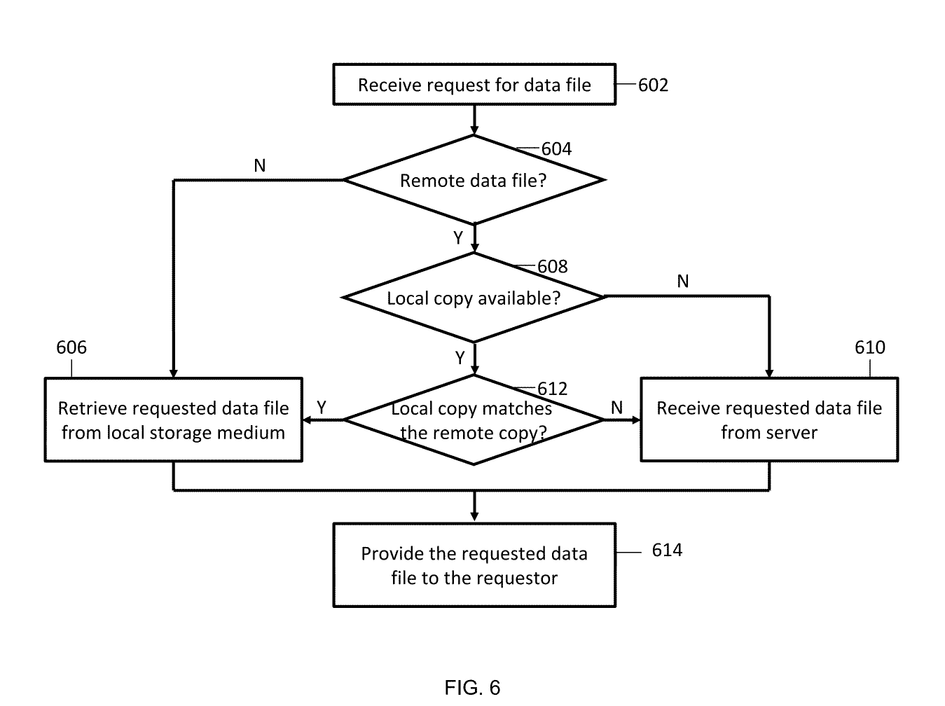

In some embodiments, the client 106 can maintain a list of remote data files that has already been downloaded previously and stored at a local storage medium. The client 106 can use this information to determine if the client 106 can reuse the local copy of the remote data files in case the user requests the same remote data file at a later point in time. This way, the client 106 does not have to re-download remote data files that have already been downloaded, unless the remote data files have been modified since the client downloaded them the last time. FIG. 6 illustrates a flow diagram illustrating an operation of a client when a user requests the client to provide a remote data file that has previously been downloaded by the client, in accordance with certain embodiments of the disclosed subject matter.

In step 602, the client 106 can receive a request, from a user, to provide contents of a data file. In step 604, upon receiving the request from the user, the client 106 can determine if the identified file is a local data file or a remote data file. If the identified file is a local data file, then the client 106 can proceed to step 606 to retrieve the data file from a local storage medium. If the identified file is a remote data file, then the client can proceed to step 608. In step 608, the client 106 determines if a copy of the requested remote data file is already available at a local storage medium (e.g., the requested data file was stored when the client 106 downloaded the data file during the last access). To this end, the client 106 can compare the file identifier of the requested file to the list of data files that have previously been downloaded and stored at a local storage medium. If a copy of the requested remote data file is not available at a local storage medium, then the client 106 can proceed to step 610 to download the requested data file from the server 104. Step 610 can be substantially similar to step 408 (FIG. 4). If a copy of the requested remote data file is already available at a local storage medium, then the client can proceed to step 612 to determine if the requested remote data file has been modified since it was last downloaded.

In step 612, the client 106 can determine if the requested remote data file has been modified since it was last downloaded. To this end, in some embodiments, the client 106 can send a signature request to the server 104, requesting the server 104 to provide a signature of the current version of the requested data file stored at the server 104. The signature of a data file can include one or more of a time stamp of the data file, the file size of the data file, a hash value of the data file, such as a message-digest 5 (MD5) checksum or an output of a hash function operating on the data file, a portion of the data file within a predefined range of bits, or any other suitable signature or combination of signatures. In response to the signature request, the server 104 can compute the signature of the requested data file and provide the signature to the client 106. Once the client 106 receives the signature, the client 106 can then compare the received signature of the remote data file to the signature of the local copy stored on its local storage medium. If the signatures of the files match, then the client 106 can determine that the local copy of the requested data file is identical to the remote copy of the requested data file (e.g., the remote data file has not been modified since it was last downloaded).

If the local copy of the requested data file is identical to the remote copy of the requested data file, then the client 106 can proceed to step 606 to retrieve the data file from a local storage medium. If the local copy of the requested data file is not identical to the remote copy of the requested data file, then the client 106 can proceed to step 610 to download the requested data file from the server 104. Then, in step 614, after steps 606 or 610, the client 106 can provide the requested file to the user.

In some embodiments, if the local copy of the requested data file is not identical to the remote copy of the requested data file, then, in step 610, the client 106 can request the server 104 to provide only the difference between the local copy and the remote copy, instead of providing the most recent version in its entirety. This way, the client 106 can quickly update its local copy and provide the most recent version to the user.

The client 106 can also upload data files to the server 104. When a user makes changes to a local copy of the remote data file, the client 106 can detect such events and start transferring the updated copy to the server 104. In some embodiments, the client 106 can determine the changes that were incorporated into the local copy and only transfer the changes to the server 104.

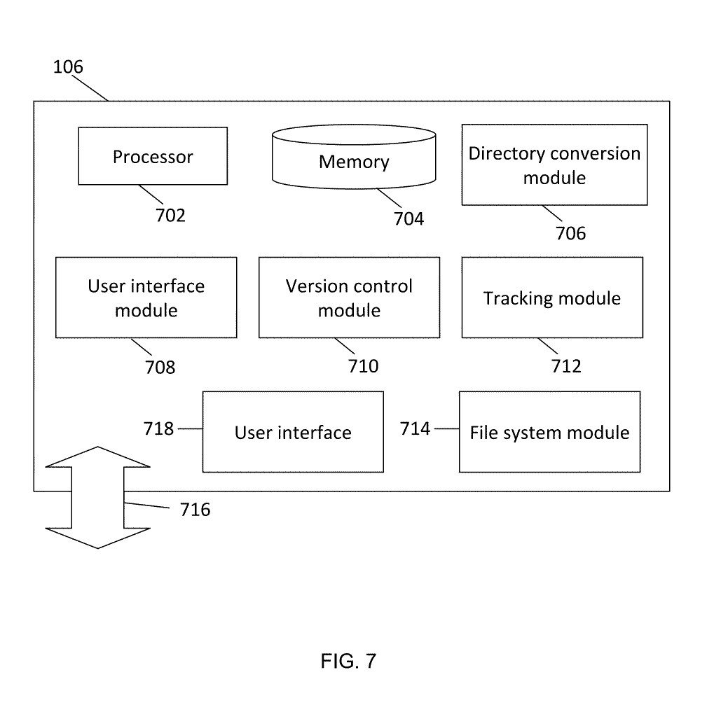

FIG. 7 illustrates a block diagram of a client in accordance with certain embodiments of the disclosed subject matter. The client 106 can include at least a processor 702, at least one memory 704, a directory conversion module 706, a user interface module 708, a version control module 710, a tracking module 712, a file system module 714, an interface 716, and a user interface 718.

A user interface 718 can be configured to provide and receive data from/to users. The user interface 718 can include a visual device, such as a monitor and an image sensor, an acoustic device, such as a microphone or a speaker, and a tactile device, such as a pressure sensor.

A directory conversion module 706 is configured to translate a local folder identifier of a local file system at the client 106 to a remote folder identifier. The local folder identifier of a local file system can include a directory (or path) identifying the folder at the client 106, whereas the remote folder identifier can include two types of information: (1) a fully qualified domain name (FQDN) of the server in which the remote folder resides, and (2) the directory (or path) of the folder at the identified server.

A user interface module 708 can provide an interface for users to interact with data files. The user interface module 708 can communicate with the user interface 718 to provide and/or receive data to/from users. The user interface module 708 can cooperate with a file manager that can present the folder structures in a file system and the files in one or more folders.

A version control module 710 is configured to determine if a copy of a remote data file, stored at memory 704, is identical to the actual remote data file at a server 104. To this end, the version control module 710 can receive a signature of the actual remote data file from the server 104, compute the local signature of the copy of the remote data file stored at memory 704, and compare the received signature to the local signature. If the compared signatures are identical, the version control module 710 can determine that the copy of the remote data file at memory 704 is identical to the actual remote data file at the server 104.

A tracking module 712 is configured to determine how much of the received data file has been consumed by the user and/or how much of the received data is yet to be consumed by the user. If the amount of remaining downloaded data is less than a predetermined threshold, the tracking module 712 can trigger the client to request the server 104 to provide additional portions of the data files.

A file system module 714 is configured to maintain a list of all data files, including both local data files and remote data files, in every folder in the file system. The file system module 714 is also configured to maintain a list of all remote files that have previously been downloaded. The file system module 714 is further configured to coordinate with the memory 704 to store local data files, remote data files that have been downloaded from a remote server, information about the data files, such as metadata, and any other suitable information about the data files.

The directory conversion module 706, the user interface module 708, the version control module 710, the tracking module 712, and the file system module 714 can be implemented in software, which may be stored in memory 704. FIG. 7 shows client 106 having separate modules 706, 708, 710, 712, and 714 that perform the above-described operations in accordance with certain embodiments of the disclosed subject matter. In other embodiments of the invention, client 106 can include additional modules, less modules, or any other suitable combination of modules that perform any suitable operation or combination of operations. The memory 704 can be a non-transitory computer readable medium, flash memory, a magnetic disk drive, an optical drive, a programmable read-only memory (PROM), a read-only memory (ROM), or any other memory or combination of memories. The software runs on a processor 702 capable of executing computer instructions or computer code. The processor 702 might also be implemented in hardware using an application specific integrated circuit (ASIC), programmable logic array (PLA), field programmable gate array (FPGA), or any other integrated circuit.

An interface 716 provides an input and/or output mechanism to communicate over a network. The interface 716 enables communication with servers, as well as other network nodes in the communication network 102. The interface 716 is implemented in hardware to send and receive signals in a variety of mediums, such as optical, copper, and wireless, and in a number of different protocols some of which may be non-transient.

The client 106 can include user equipment of a cellular network. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The client 106 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The client 106 is configured with one or more processors 702 that process instructions and run software that may be stored in memory. The processor 702 also communicates with the memory and interfaces to communicate with other devices. The processor 702 can be any applicable processor such as a system-on-a-chip that combines a CPU, an application processor, and flash memory. The client 106 can also provide a variety of user interfaces such as a keyboard, a touch screen, a trackball, a touch pad, and/or a mouse. The client 106 may also include speakers and a display device in some embodiments.

The server 104 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 104. A task can be a software process that performs a specific function related to system control or session processing. Three types of tasks operate within the server 104 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 104 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 104 by monitoring the various software and hardware components of the server 104. Recovery control task subsystem is responsible for executing a recovery action for failures that occur in the server 104 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 104 with an ability to set, retrieve, and receive notification of server configuration parameter changes and is responsible for storing configuration data for the applications running within the server 104. A resource management subsystem is responsible for assigning resources (e.g., processor and memory capabilities) to tasks and for monitoring the task's use of the resources.

In some embodiments, the server 104 can reside in a data center and form a node in a cloud computing infrastructure. The server 104 can also provide services on demand. A module hosting a client is capable of migrating from one server to another server seamlessly, without causing program faults or system breakdown. The server 104 on the cloud can be managed using a management system.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A non-transitory computer readable medium having executable instructions operable to cause a data processing apparatus to:
provide, to a user interface coupled to the data processing apparatus, a list of data files, the data files including at least one remote data file and at least one local data file, wherein the at least one remote data file is provided to the user interface as a local data file;
receive, from the user interface, a first data request requesting the data processing apparatus to provide contents of a data file;
determine that the requested data file is a remote data file that is maintained at a server;
based on the determination, send a second data request via a computer network to the server, requesting the server to provide the data file to the data processing apparatus; and
receive a response to the second data request from the server, the response including the contents of the data file.

2. The computer readable medium of claim 1, wherein the first data request comprises a local file identifier identifying the data file and the second data request comprises a remote file identifier identifying the data file stored at the server.

3. The computer readable medium of claim 2, further comprising executable instructions operable to cause the data processing apparatus to convert the local file identifier to the remote file identifier.

4. The computer readable medium of claim 1, comprising executable instructions operable to cause the data processing apparatus to:
in response to receiving the response to the second data request from the server, determine that the contents of the data file received from the server comprises a first portion of the requested data file; and
send an additional data request to the server, requesting the server to provide a second portion of the data file.

5. The computer readable medium of claim 1, further comprising executable instructions operable to cause the data processing apparatus to:
determine that the contents of the data file are available at a storage medium coupled to the data processing apparatus;
determine a first signature of the previously downloaded contents of the data file and a second signature of the contents of the data file stored at the server; and
compare the first signature and the second signature to determine whether the contents of the data file stored at the local storage medium matches the contents of the data file stored at the server.

6. The computer readable medium of claim 5, wherein the executable instructions operable to cause the data processing apparatus to determine the second signature comprises executable instructions operable to cause the data processing apparatus to receive the second signature from the server.

7. The computer readable medium of claim 1, further comprising executable instructions operable to cause the data processing apparatus to:
receive a list request requesting the data processing apparatus to provide the list of data files in a folder;
send an information request via the computer network to the server, requesting the server to provide information about one of the data files to the data processing apparatus;
receive a response to the information request from the server, the response including the information about the one of the data files; and
provide the list of data files, the list including the information about the one of the data files received from the server.

8. The computer readable medium of claim 7, wherein the information about the one of the data files comprises metadata of the one of the data files.

9. The computer readable medium of claim 8, wherein the metadata of the one of the data files includes at least one of a name of the one of the data files, a file size indicator indicating a size of the one of the data files, a created time identifier indicating a time at which the one of the data files was created, and a time stamp indicating a time at which the one of the data files was last modified.

10. An apparatus comprising:
a user interface configured to provide and receive data;
one or more interfaces configured to provide communication with a server via a communication network; and
a processor, in communication with the one or more interfaces, and configured to run a module stored in memory that is configured:
to provide, to the user interface, a list of data files including at least one remote data file and at least one local data file, wherein the at least one remote data file is provided to the user interface as a local data file,
to receive, from the user interface, a first data request requesting the apparatus to provide a contents of a data file,
to determine that the data file is associated with a remote data file at the server,
based on the determination, to send a second data request to the server to provide the remote data file to the apparatus, and
to receive a response to the second data request from the server, the response including the contents of the data file.

11. The apparatus of claim 10, wherein the first data request comprises a local file identifier identifying the data file at the apparatus and the second data request comprises a remote file identifier associated with the data file stored at the server.

12. The apparatus of claim 11, wherein the module is further configured to convert the local file identifier to the remote file identifier.

13. The apparatus of claim 11, wherein the module is further configured to receive a list request requesting the apparatus to provide the list of data files, to send an information request to the server, requesting the server to provide information about one of the data files to the apparatus, to receive a response to the information request from the server, the response including the information about the one of the data files, and to provide the list of the data files, the list including the information about the one of the data files received from the server.

14. The apparatus of claim 13, wherein the information about the one of the data files comprises metadata of the one of the data files.

15. The apparatus of claim 10, wherein the module is further configured to, in response to the first data request, determine that the contents of the data file is available at the memory, determine a first signature of the contents of the data file at the local storage medium and a second signature of the contents of the data file stored at the server, and to compare the first signature and the second signature to determine whether the contents of the data file stored at the local storage medium matches the contents of the data file stored at the server.

16. A method comprising:
providing, to a user interface coupled to an apparatus, a list of data files, the data files including at least one remote data file and at least one local data file, wherein the at least one remote data file is provided to the user interface as a local data file;
receiving, at the apparatus from the user interface, a first data request requesting to provide contents of a data file;
determining that the requested data file is a remote data file that is stored at a server;
based on the determination, sending a second data request via a computer network to the server, requesting the server to provide the data file to the apparatus; and
receiving a response to the second data request from the server, the response including the contents of the data file.

17. The method of claim 16, wherein the first data request comprises a local file identifier identifying the data file at the apparatus and the second data request comprises a remote file identifier associated with the data file stored at the server.

18. The method of claim 17, further comprising converting the local file identifier to the remote file identifier.

19. The method of claim 16, further comprising:
determining that the contents of the data file received from the server comprises a portion of the requested data file; and
sending an additional data request to the server, requesting the server to provide additional portions of the data file.

20. The method of claim 16, further comprising:
determining that the contents of the data file is available at a local storage medium coupled to the apparatus;
determining a first signature of the contents of the data file at the local storage medium and a second signature of the contents of the data file stored at the server; and
comparing the first signature and the second signature to determine whether the contents of the data file stored at the local storage medium matches the contents of the data file stored at the server.
